(19) United States
(12) Patent Application Publication
(10) Pub. No.: US 2012/0061076 A1
(43) Pub. Date: Mar. 15, 2012

(54) Stop Collar for Tubulars

(75) Inventors: Troy L. McDaniel, Weatherford, TX (US); Christopher W. Welborn, Mineral Wells, TX (US); Jean Buytaert, Mineral Wells, TX (US)

(73) Assignee: FRANK'S INTERNATIONAL, INC., Houston, TX (US)

(21) Appl. No.: 12/879,996

(22) Filed: Sep. 10, 2010

(51) Int. Cl. E21B 17/10; B23P 11/00

(52) U.S. Cl. 166/241.6; 29/428

(57) ABSTRACT

Embodiments of the disclosure may provide a stop collar for tubulars, wherein the collar includes an annular stop collar member formed from at least one collar segment, and a weld joint attaching each of the at least one collar segments together, each of the weld joint(s) having a head and stem, wherein in certain embodiments the head has a width that is generally greater than the stem.

### BACKGROUND

Various downhole tools used in the oilfield industry require collars to secure equipment to tubulars and the like. These collars are generally cylindrical in shape (e.g., when assembled), include a hollow interior to receive the tubular therethrough, and may include a plurality of set screws that are used to secure the collar to (around) the OD of the tubular. Collars may be unitary or hinged. Hinged collars, such as the conventional hinged collar 150 shown in FIG. 1A, are sometimes thought of as being easier to install on a tubular, however the hinge 154 and the securing assembly 152 add a significant amount of unwanted width (e.g., to the OD) to the collar 150. This additional OD is problematic in tight hole conditions, e.g., where the borehole has cuttings, irregular ledges, etc. that reduce the space available to pass tools through the borehole, and also in low clearance holes, e.g., boreholes where the casing program provides reduced positive OD space or clearance through which tools are passed. Additionally, conventional hinged collars 150 are also problematic in that the hinge 154 and securing assembly 152 add stress failure points to the collar that are possible rupture points. Unitary collars on the other hand, such as the conventional unitary collar 160 illustrated in FIG. 1B, are generally known to be stronger and thinner, e.g., smaller positive OD, than hinged collars, and may generally be manufactured from a cut length of a tubular or by rolling one or more pieces of metal into arc shaped members that are cooperatively secured together, e.g., welded, to form an annular shaped collar. Unitary construction has several advantages, however, cost is often prohibitive, as the cost of raw materials and the associated processing costs, e.g., cutting a relatively expensive tubular into circular sections, is significant. As such, most non-hinged collars are generally manufactured from a rolled metal piece that is secured together via a linear weld (that is parallel to the longitudinal axis of the collar member) to form the desired annular collar member in a more cost effective manner.

One challenge with welded segment or section collars is that during installation it is possible to generate significant force (e.g., radial force) on the collar when the set screws are tightened. This force has shown to rupture the conventional linear weld joint between the collar segments. As such, there is a need for a stop collar for tubular that overcomes the weaknesses of conventional stop collar linear weld joints.

### SUMMARY

Embodiments of the disclosure may provide a stop collar for a tubular, for example, for petroleum production equipment. The stop collar provides a relatively thin unitary collar that is increasingly resilient to ruptures that often times occur when tightening collar set screws. The collar may be manufactured from one, two, or more sections welded together at an interlocking weld joint to form the desired circular collar. The interlocking weld joint may include a head and stem portion, wherein the head has a width that is greater than the stem, thus providing both increased weld joint length and increased shear strength in the weld joint.

Embodiments of the disclosure may further provide a stop collar for tubulars. The stop collar may include an annular stop collar member formed from a plurality of collar segments, and a weld joint attaching each of the plurality of collar segments together to form a unitary annular collar, the weld joint having a head and stem, wherein the head has a width that is greater than the stem to form an interlocking weld joint.

Embodiments of the disclosure may further provide a stop collar for tubulars, wherein the stop collar may include a plurality of collar segments each having corresponding interlocking terminating ends, wherein the interlocking terminating ends include a head having an increasing width as the head extends away from an opposing collar segment, and a welded joint formed over the interlocking terminating ends.

Embodiments of the disclosure may further provide a method for manufacturing a stop collar for tubulars. The method may generally include forming a plurality of collar segments, machining terminating ends of the plurality of collar segments to include interlocking joint features, assembling the plurality of collar segments into a unitary circular collar having a plurality of interlocking joints, and welding along the interlocking joint to secure the interlocking joints together.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale in the following Figures. In fact, the dimensions of the various features may be arbitrarily increased or reduced for clarity of discussion.

FIG. 1A illustrates a conventional hinged collar;

FIG. 1B illustrates a conventional unitary collar;

FIG. 1C illustrates a perspective view of an exemplary stop collar of the disclosure;

FIG. 2 illustrates a top view of an exemplary stop collar of the disclosure;

FIG. 3 illustrates a side view of an exemplary stop collar of the disclosure; and

FIGS. 4a-h each illustrate a schematic views of exemplary weld joint configurations that may be used in the exemplary stop collar of the disclosure to secure collar segments together.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Finally, the exemplary embodiments presented below may be combined in any combination, e.g., any element from one exemplary embodiment may be used in any other exemplary embodiment, without departing from the scope of the disclosure.

Additionally, certain terms are used throughout the following description and claims to refer to particular components of the disclosure. As one skilled in the art will appreciate, various entities may refer to the same component by different names, and as such, the naming convention for the elements described herein is not intended to limit the scope of the invention, unless otherwise specifically defined. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, e.g., “A or B” is intended to be synonymous with “at least one of A and B,” unless otherwise expressly specified herein.

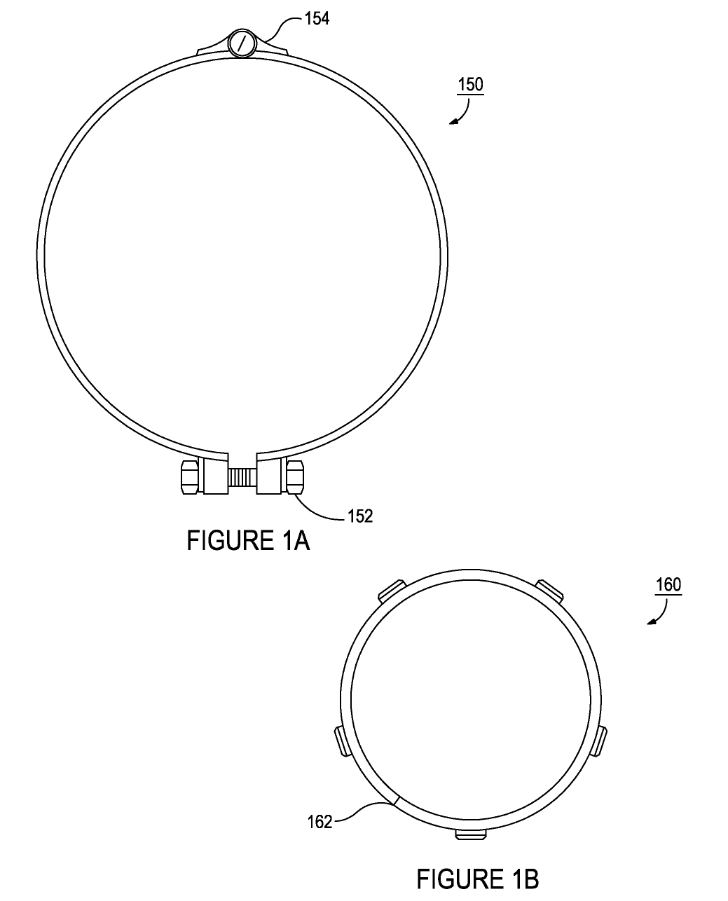

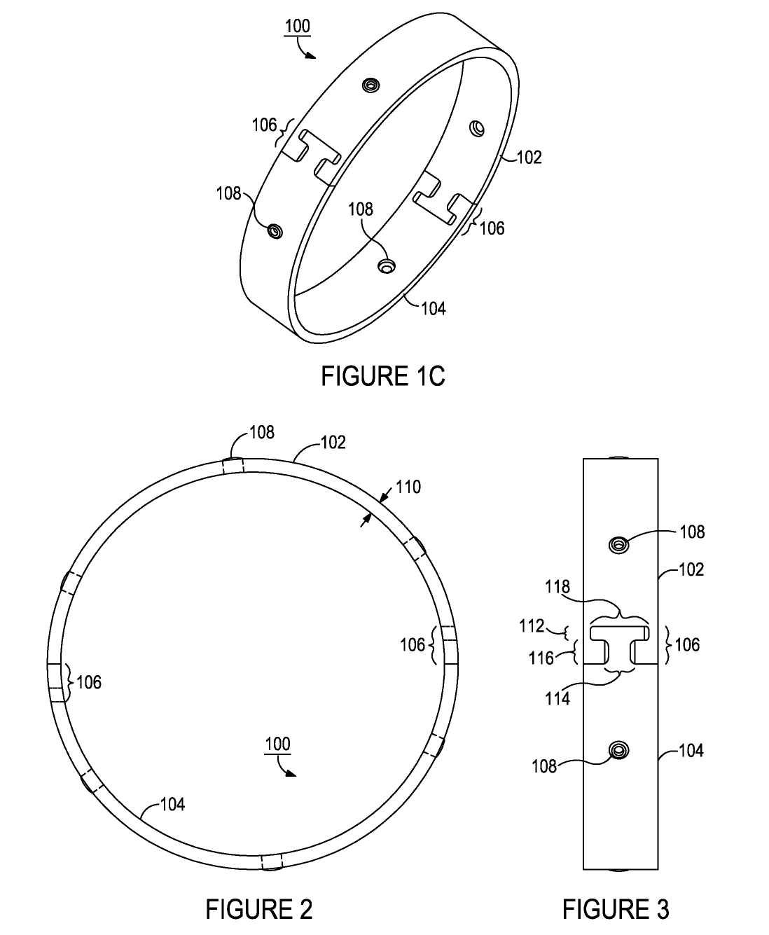

FIG. 1 illustrates a perspective view of an exemplary stop collar 100 of the disclosure. The exemplary stop collar 100 may include two semi-circular segments 102, 104 that are joined together at interlocking weld joints 106 (further discussed herein) to form the unitary circular (e.g., circular inner diameter) stop collar 100. In other embodiments, three or more collar segments 102, 104 may be welded together at multiple (four or more) weld joints 106 to again form a unitary circular stop collar 100. The stop collar may include a plurality of set screws 108 (e.g., circumferentially spaced) threaded through the wall height or thickness 110 of the stop collar 100 (as also shown in FIG. 2), wherein the set screws are configured to extend radially inward from the stop collar 100 to engage an outer surface of a tubular, drill pipe, or other generally cylindrical production equipment that may be placed in a wellbore. For example, in one embodiment the stop collar 100 of the present disclosure may be used to secure a centralizer (not shown) to a tubular via the set screws 108. More particularly, the stop collar 100 may be positioned around the exterior of the tubular and the set screws tightened to engage the outer surface of the tubular to secure the stop collar 100 thereto.

FIG. 2 illustrates a top view of the exemplary stop collar 100 of the disclosure. FIG. 2 illustrates the set screws 108 as being formed through the wall height or thickness 110 of the stop collar 100 so that the set screws 108 may be actuated (e.g., screwed inwardly) from the (e.g., radially) outer surface to cause the (e.g., radially) inner surface of the set screws 108 to extend inward to engage the tubular positioned therein. Additionally, FIG. 2 generally shows the wall thickness 110 of the stop collar 100 compared to the overall width (edge to edge distance across, for example, the weld joint, which is also generally referred to as the height of the collar) of the stop collar 100, as shown in FIGS. 1 and 3. Although the present disclosure is not limited to any particular wall thickness 110 or collar height, in at least one embodiment of the disclosure the height of the stop collar 100 may be at least twice the wall thickness 110. FIG. 2 also illustrates an exemplary configuration of the plurality of set screws 108, wherein six set screws 108 are equally spaced from one another by about 60° around the stop collar 100. In other embodiments any number of set screws 108 may be used, and the set screws may be equally spaced by about 120° (e.g., 3 set screws), about 90° (e.g., 4 set screws), about 72° (e.g., 5 set screws), about 51.4° (e.g., 7 set screws), about 45° (e.g., 8 set screws), or any other angle, spacing, or number of set screws. FIG. 2 also illustrates that the weld joint 106 extends through the wall height or thickness 110 of the stop collar 100.

FIG. 3 illustrates a side view of an exemplary stop collar 100 of the disclosure focusing on the interlocking weld joint 106. More particularly, the weld joint 106 illustrated in FIG. 3 generally includes a “T-shaped” weld joint that has a head width 118 (the overall width of the top portion of the T) that is greater than a stem width 114 (the upright base supporting the T). This interlocking weld configuration with the head width 118 being larger than the stem width 114 significantly improves the weld strength of the weld joint 106, and therefore, significantly reduces pop failures at the weld joint, e.g., when the set screws 108 are tightened. The head width 118 being larger than the stem width 114 increases the joint strength in two ways: first, the head being larger than the stem creates an interlocking mechanical joint that must be sheared to fail, e.g., the head must be sheared from the stem to fail; and second, the head width 118 sizing causes the weld line (linear length of the weld from edge to edge (on the collar) to be significantly longer that merely the linear collar width, which also significantly increases the strength of the weld joint.

In another embodiment of the disclosure, the interlocking features at the weld joint may comprise only a portion of the thickness of the segments 102, 104. For example, the terminating end of one segment may be machined or otherwise manufactured with an interlocking feature, however, the feature may be machined into only a portion of the overall thickness of the terminating end of the segment 102, 104. The terminating end of another segment 102, 104 may also be machined or manufactured with a corresponding (generally inverse) feature. As such, the two terminating ends having features machined into only a portion of the thickness of the respective segments 102, 104 may be machined, sized, and/or otherwise manufactured to be joined together to form an interlocking joint that may be permanently welded together.

In another embodiment of the disclosure, the interlocking features at the weld joint may be formed, machined, or otherwise manufactured into the terminating ends of segments 102, 104, and the segments 102, 104 that cooperatively form the stop collar 100 may be of equal length. Therefore, in this embodiment, the segments 102, 104 may be substantially identical in construction, e.g., each having identical terminating ends. For example, two substantially identical (semicircular) segments 102, 104 having a head on a first end and a receiving element corresponding to the head formed into a second, may be assembled to form a continuous circle or collar. Similarly, three or more substantially identical segments may be manufactured and assembled in the same manner to form the collar.

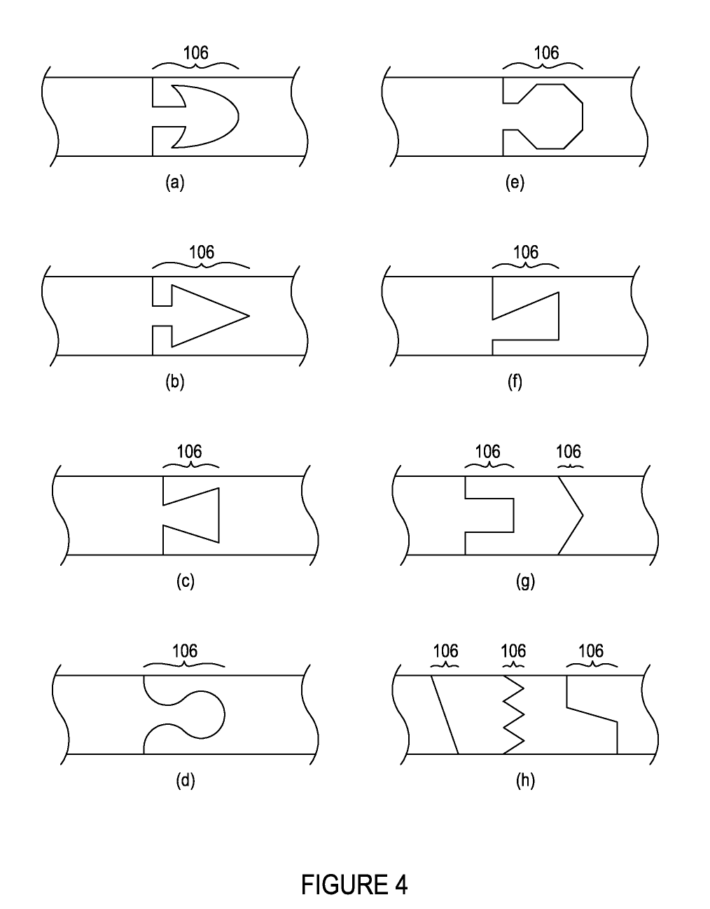

Further detailing the weld joint 106 in FIG. 3, the overall width of the weld joint 106 is the edge to edge distance of the collar. The width of the stem of the weld joint is denoted by 114 and the height of the stem is denoted by 116. The height of the head is denoted by 112 and the width of the head is denoted by 118. In at least one embodiment of the disclosure, the head width 118 is greater than the stem width 114, regardless of the shape of the head, thus creating the aforementioned interlocking weld joint 106. In other embodiments the head may be shaped in other configurations than the T-shape illustrated in FIGS. 1 and 3, and in these embodiments, the head width 118 may be larger than the stem width 114, regardless of the head or stem shape. For example, the stem height 116 may be essentially zero, such that the entire weld joint comprises a head (See, FIGS. 4c, d, and f, for example). In other embodiments, the stem height 116 may be less than the head height 112 (See, FIGS. 4a, b, and e, for example), thus creating a relatively large head compared to the stem to increase the shearing force required to cause a joint failure.

FIGS. 4a-h illustrate schematic views of exemplary weld joints 106 that may be used in the exemplary stop collar of the disclosure. As is generally shown and described below, the weld joints 106 may be in a plurality of shapes and sizes. In some embodiments of the disclosure the weld joint 106 will form an interlocking head, and in others, the weld joint 106 may not include an interlocking feature. Regardless of the size or shape of the weld joint 106, the respective sides of the weld joint 106 may be formed by various manufacturing processes, including machining, mechanical cutting, water or laser jet cutting, stamping, pressing, or any other manufacturing process capable of generating parts of various sizes and shapes.

FIG. 4a illustrates a mushroom-shaped head in an interlocking weld joint 106. The head generally includes a rounded top that connects back to a stem having a width that is less than the width of the head, thus creating a higher shear force interlocking joint. The interconnection between the stem and head is shown as being downwardly curved lines (away from the head), however, embodiments of the disclosure contemplate that these lines may also be linear and/or at any angle. Similarly, although the stem is shown with parallel sides, embodiments of the invention contemplate that the sides of the stem may be at any angle desired and may be parallel or not to each other. Further still, the stem connects to the edge of the collar via edge lines, which are the lines extending from the edge of the collar to the base of the stem that are shown as being generally perpendicular to the edge of the collar and extending inward therefrom toward the stem. Embodiments of the disclosure are not limited to any particular configuration of edge lines, as the edge lines may be of any length and may be positioned at any angle with respect to the edge of the collar. Additionally, the edge lines may be symmetric to each other of not as desired.

FIG. 4b illustrates a triangle-shaped head in a weld joint 106. The head generally includes a wide base portion (closer to the stem) and a narrower top portion (more distant from the stem), and the stem is generally narrower in width than the base of the triangle. This configuration again creates a head that is larger than the stem and higher shear forces are required for joint failure. The triangle-shaped head may generally be of any size or configuration, e.g., the angles of the triangle may be equal or different and may be in any configuration. Similarly, in the illustrated configuration of FIG. 4b, the base of the triangle is generally perpendicular to the stem, however, embodiments of the disclosure are not limited to any particular orientation, as the stem sides may be angled, parallel to each other or not, and the triangle base lines may be at any angle (equal to each other or not in the case of a non-triangle shaped head, for example) with respect to the stem sides. Regardless of the sides or head configuration, in this exemplary embodiment the head width is again larger than the stem width, this increasing the weld joint 106 strength.

FIG. 4c illustrates head configuration wherein the stem height is essentially zero. More particularly, in FIG. 4c, the head essentially connects directly to lines directed to the edge of the collar, and as such, there is no defined stern portion between the edge lines and the head portion in this embodiment. Rather, this embodiment provides a head of increasing width as the head extends away from the joint lines that connect to the edge of the collar, and in at least one embodiment, the edge lines may be considered as a stem. More particularly, although the edge lines are shown as being positioned perpendicular from the edge of the collar, embodiments of the disclosure are not limited to this configuration. Rather, the edge lines may be positioned at another angle (other than 90°) with respect to the edge of the collar, and in this configuration, the edge lines may form a stem that connects the head portion directly to the edge. The shape of the head is shown as being symmetric and trapezoidal, however, other shapes are also contemplated. Regardless of the actual shape of the head, the head increases in width as it extends from the weld joint lines that connect to the edges (at any desired angle), thus again creating a weld joint that requires increased shear force to overcome the joint strength (in addition to the increased weld strength do to the increased length).

FIG. 4d illustrates a circular or teardrop head configuration with an integral stem. In this embodiment the circular shaped head connects to the edge connecting weld lines via the rounded or arc shaped stem. The circular shaped head increases in width as it extends away from the edge lines to again require increased shear force to overcome or fail the weld joint. The radius of the circle shaped head in this embodiment may be any radius that is less than about ½ the collar width, however, generally the radius may be less than about ¼ of the collar width to provide for sufficient collar material to surround the circular shaped head. Applicants note that the head illustrated in FIG. 4d may also be modified to include a stem portion that may have parallel or non-parallel sides that generally extend away from the edge connecting joint lines toward the head portion of the weld joint 106. However, in embodiments where a stem is included, the head may have a greater width than the stem to maintain increased shear strength.

FIG. 4e illustrates an exemplary weld joint 106 where the head is octagon shaped and greater in width than the stem. In another embodiment an octagon shaped head may be used without a stem, e.g., the head may be directly connected to the edge lines, which may also be at any orientation with respect to the collar edges. In yet another embodiment, other shapes may be used, such as a henagon, diagon, trigon, tetragon, pentagon, hexagon, heptagon, nonagon, decagon, or other desired polygon shape. Regardless of shape, the polygon may generally have a width that increases as it extends from the edge connecting lines, this creating the desired shear resistance effect discussed herein.

FIG. 4f illustrates another exemplary head configuration wherein a trapezoid shaped head is implemented. In this embodiment a trapezoid having an increasing width as it extends away from the edge lines connecting to the edge of the collar 100 may be used. The trapezoid shape may have sides in any orientation or angle, may include parallel sides or not, and may contain varying degrees of symmetry, as shown in FIG. 4c, for example. Although the trapezoid in FIG. 4f is shown without a stem, embodiments of the disclosure may include a stem connecting the edge lines to the trapezoid, where the stem may include parallel or non-parallel sides that may or may not connect to the edge via the edge lines, e.g., the stem sides may angle toward and connect to the edges themselves in some embodiments.

FIG. 4g illustrates two exemplary embodiments of weld joints 106, however, the weld joints 106 of this embodiment does not include a head having an increased size over a stem portion. As such, this embodiment does not provide the increased shear strength that the embodiments described above provide. However, the additional weld length resulting from the head significantly increases the weld joint strength over conventional linear weld joints. For example, the exemplary weld joint 106 on the left side of FIG. 4g has a square or rectangle shaped head that provided a significantly increased weld line length, but does not provide for an interlocking head feature discussed above. The second exemplary weld joint 106 illustrated in FIG. 4g is on the right side of the figure and includes an angled weld joint 106. This embodiment again provides a significantly increased weld joint length when compared to conventional linear joints, and as such, provides significantly improved resilience to shearing.

Similarly, FIG. 4h illustrates three exemplary weld joints 106. The first exemplary weld joint 106 is on the left side and includes a linear weld joint 106 that connects the respective edges of the collar 100, however, the weld joint 106 is angled (e.g., skewed) so that the length of the weld joint 106 is substantially greater than the width of the collar. Similarly, an exemplary saw tooth-shaped weld joint 106 is illustrated in the middle of FIG. 4h. The weld joint 106, which again does not provide the shear strength of an increased head-type of joint, nevertheless provides increased shear resilience strength over conventional linear weld joints as a result of the weld line length being nearly twice the length of a convention weld line the perpendicularly connects the collar edges. The third exemplary weld joint 106 is shown on the right side of FIG. 4h and includes a three segment line wend joint 106. The three segments may be positioned at any orientation, as the general goal of the segments is to increase the linear weld line length to increase the shear resiliency of the weld joint 106. Applicants note that other shapes may also be implemented to provide for an increased weld length over conventional linear welds. Applicants note that tests have shown that as the length of weld joint 106 or weld line increases, so does the overall force required to overcome or fail the joint. As such, in these embodiments (FIGS. 4g and h), the increased weld length provides the increased joint strength. Applicants note that the illustrated joint shapes have shown to increase the weld length by about 30% to about 100%, thus proportionally increasing the weld joint 106 strength.

In another embodiment, a method for manufacturing one of the above noted exemplary stop collars 100 may be provided. In this embodiment two semicircular collar segments 102, 104 may first be formed from a metal, metal alloy, or any other desired or suitable material. In another embodiment more than 2 arc-shaped segments may be used, wherein the cumulative shape of the arcs when assembled forms the desired annular collar. The individual segments may be formed from, for example, a flat strip that is rolled, pressed, processed in a press breaking machine, or otherwise formed into the desired arc curvature and length. Regardless of the number of segments 102, 104, the respective terminating ends of the collar segments 102, 104 may be machined or otherwise processed or manufactured to include an (optional) interlocking feature, as described herein. In embodiments where an interlocking feature is not used, the respective ends of the segments 102, 104 may be machined or otherwise processed or manufactured to fit together when joined. Returning to embodiments where an interlocking head is used, the head portion may be machined, processed or otherwise manufactured into one terminating end of a segment 102, 104 and another terminating end of a segment 102, 104 may be machined, processed, or otherwise manufactured with a feature sized and shaped to receive the head portion therein to form an interlocking joint. For example, one end of a segment may be machined with a positive image of a head and stem portion, while a corresponding end of another segment to be joined thereto may be machined, processed, or otherwise manufactured with an inverse or negative image of the head to create the interlocking joint. The head portion may be of essentially any shape, including T-shaped, triangle shaped, mushroom shaped, circular shaped, polygon shaped, or trapezoid shaped. In at least one embodiment, the width of the head may increase is the head extends from the joint, thus facilitating the interlocking portion of the joint.

The above noted machining, processing, or otherwise manufacturing the terminating ends is intended to cover all processes for forming the terminating ends into the segments. For example, the inventors contemplate that the features may be formed into the ends of the segments by conventional machining techniques, water or laser jet cutting, punching, conventional cutting techniques, shearing, or stamping. Regardless of the process chosen, the process may be repeated for as many segment terminating ends as needed to form the annular collar 100. Once the interlocking features are formed, the respective segments may be assembled to form the unitary stop collar and permanently joined together via an appropriate form of welding (as desired) along the interface line between positive and negative portions of each of the interlocking joints. The welding process will generally include welding along the entire joint line from edge to edge of the collar, and in some embodiments, the weld may be conducted on each side of the collar (inner surface or ID of the collar 100 and the outer surface or OD of the collar 100). In other embodiments, the welding may include sections of the length of the joint line. Once the joints are welded, they may be post processed (grinding, brushing, smoothing, etc.) as desired for the appearance or dimensional constraints of the final product. The segments 102, 104 or assembled collar 100 may be drilled and threaded to receive the desired number of set screws 108, as shown in FIGS. 1-3, and the set screws may be installed therein.

The foregoing has outlined features of several embodiments so that those skilled in the art may better understand the present disclosure. Those skilled in the art will also appreciate that the present disclosure may be used as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure, as defined by the following claims.

We claim:

1. A stop collar for tubulars, comprising:
at least one stop collar segment having terminating ends; and
at least one weld joint attaching the terminating ends of the at least one collar segment together to form a unitary annular collar, the at least one weld joint having a head and stem, wherein the head has a width that is greater than the stem to form an interlocking weld joint.

2. The stop collar of claim 1, wherein the head has a height that is greater than a height of the stem.

3. The stop collar for tubulars of claim 1, wherein head is T-shaped.

4. The stop collar for tubulars of claim 1, wherein the head is triangle shaped, mushroom shaped, circular shaped, polygon shaped, teardrop shaped, or trapezoid shaped.

5. The stop collar for tubulars of claim 4, wherein the stem connects to edges of the stop collar via edge lines.

6. The stop collar for tubulars of claim 1, wherein the stem comprises a segment of collar material connecting a base of the head to edge lines of the collar member.

7. The stop collar for tubulars of claim 1, wherein the collar segments are substantially identical.

8. A stop collar for tubulars, comprising:
a plurality of collar segments each having corresponding interlocking terminating ends, wherein the interlocking terminating ends include a head having an increasing width as the head extends away from an opposing collar segment; and
a welded joint formed over the interlocking terminating ends.

9. The stop collar for tubulars of claim 8, wherein the head portion is T-shaped, has a height that is greater than a height of a connecting stem, and has a width that is greater than a width of the connecting stem portion.

10. The stop collar for tubulars of claim 8, wherein the head is triangle shaped, mushroom shaped, circular shaped, polygon shaped, teardrop shaped, or trapezoid shaped.

11. The stop collar for tubulars of claim 10, further comprising a stem connecting the head to edges or edge lines of the collar.

12. The stop collar for tubulars of claim 11, wherein a height of the head is greater than a height of the stem portion.

13. The stop collar for tubulars of claim 12, wherein the welded joint includes the entirety of the interlocking terminating ends.

14. The stop collar for tubulars of claim 13, further comprising edge lines connecting edges of the collar to the stem, the edge lines being part of the welded joint.

15. The stop collar for tubulars of claim 13, further comprising a plurality of equally spaced set screws formed through the collar and configured to secure the collar to a tubular.

16. The stop collar for tubulars of claim 8, wherein the plurality of collar segments are substantially identical.

17. A method for manufacturing a stop collar for tubulars, comprising:
forming a plurality of collar segments;
machining terminating ends of the plurality of collar segments to include interlocking joint features;
assembling the plurality of collar segments into a unitary circular collar having a plurality of interlocking joints; and
welding along the interlocking joint to secure the two interlocking joints together.

18. The method of claim 17, wherein machining terminating ends to include interlocking joint features comprises machining a head that is T-shaped, triangle shaped, mushroom shaped, circular shaped, polygon shaped, teardrop shaped, or trapezoid shaped.

19. The method of claim 18, further comprising machining the interlocking joint feature to include receiving an end sized and shaped to receive the head in an interlocking manner.

20. The method of claim 19, further comprising post weld machining over a formed weld joint to form a post manufacture collar dimensions or appearance.

21. The method of claim 18, wherein welding the entire length of the interlocking joint further comprises welding both an inner diameter surface of the collar and an outer diameter surface of the collar along the interlocking joint.

22. The method of claim 19, further comprising forming threaded bores through the unitary circular collar, the threaded bores being configured to receive set screws therein for use in securing the unitary circular collar to an outer surface of a tubular.

23. The method of claim 17, wherein forming the plurality of collar segments comprises rolling, pressing, or press breaking.
